(19) United States
(12) Patent Application Publication
(10) Pub. No.: US 2005/0038204 A1
(43) Pub. Date: Feb. 17, 2005

(54) Increased pot-life urethane coatings

(76) Inventor: David N. Walters, Slippery Rock, PA (US)

Correspondence Address: PPG INDUSTRIES, INC.;Intellectual Property Department, One PPG Place, Pittsburgh, PA, 15272, US

(21) Appl. No.: 10/641,310

(22) Filed: Aug. 14, 2003

(51) Int. Cl. C08G 18/00

(52) U.S. Cl. 525/452

(57) ABSTRACT

A two-component film-forming composition that includes a first component containing a polyol and a catalyst; and a second component containing an unblocked polyisocyanate. At least one of the components includes a volatile carboxylic acid compound and both components are substantially free of mercapto compounds and polyphenols. The composition is used to coat a substrate by mixing the two-component film-forming composition, applying the mixed composition to at least a portion of a surface of the substrate to form a coating film, and curing the coating film. The method provides substrates coated with the two-component film-forming composition.

### TECHNICAL FIELD OF THE INVENTION

The present invention relates to curable compositions and, more particularly, to low or ambient temperature curable coating compositions which are useful in automotive refinish applications.

### BACKGROUND OF THE INVENTION

In the area of automotive refinish, coating formulations are often formulated as two-pack systems. The first pack typically contains a resin, in many cases a polyol, and the second pack typically contains a curing or crosslinking agent, in many cases a polyisocyanate. The two packs are normally mixed together just prior to application of the coating.

Upon mixing of the two packs, a chemical reaction begins between reactive functional groups on the resin (hydroxyl groups in the case of a polyol) and reactive functional groups on the curing or crosslinking agent (isocyanate groups in the case of a polyisocyanate), ultimately leading to gellation. The period of time before gellation, where the viscosity of the mixture builds but remains low enough to allow application of the coating onto a substrate, is typically referred to as the “pot life” of the coating.

Rapid curing of a coating is often desired to increase paint shop productivity. A catalyst for the crosslinking reaction is often added to accelerate the crosslinking reaction. When the amount of catalyst is increased to speed-up the cure, other problems arise, including decreased pot life and reduced coating quality.

There are other indicia of increased productivity, e.g., how soon after application the film coating dries sufficiently to be dust-free, so that the painted article (vehicle) can be moved from the paint booth to make room for the next vehicle to be painted. The vehicle can be moved outside the paint shop, i.e., into the open air, only after the film coating has dried further so as to be free of water spotting damage.

EP 0 454 219 A1 discloses coating compositions that include polyurethanes produced via the reaction between a polyol and polyisocyanate in the presence of a complexed polyisocyanate catalyst that includes tin and/or bismuth complexed with mercapto compounds and/or polyphenols with adjacent hydroxyl groups. The polyurethane coating systems are disclosed as being readily curable at ambient temperatures and display a balance between pot life and cure speed. However, the compositions of EP 0 454 219 A1 require longer than desired dust-free and tack-free times before vehicles coated with such coating compositions can be moved outside of the paint shop.

Therefore, there is a demonstrated need in the art for a coating composition that provides a proper balance of long pot life and fast cure speed while providing a coating with good physical properties.

### SUMMARY OF THE INVENTION

The present invention is related to a two-component film-forming composition that includes (A) a first component comprised of a polyol and a catalyst; and (B) a second component comprising an unblocked polyisocyanate; wherein at least one of components (A) and (B) comprise a volatile carboxylic acid compound, and components (A) and (B) are substantially free of mercapto compounds and polyphenols.

The present invention is also directed to a method of coating a substrate that includes mixing the two-component film-forming composition described above, applying the mixed composition to at least a portion of a surface of the substrate to form a coating film, and curing the coating film.

The present invention is further directed to substrates coated with the two-component film-forming composition described above and substrates coated using the above-described method.

### DETAILED DESCRIPTION OF THE INVENTION

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

As used herein, the term “substantially free” is meant to indicate that a material is present as an incidental impurity. In other words, the material is not intentionally added to an indicated composition, but may be present at minor or inconsequential levels because it was carried over as an impurity as part of an intended composition component.

As used herein, by “thermosetting composition” is meant one which “sets” irreversibly upon curing or crosslinking, wherein the polymer chains of the polymeric components are joined together by covalent bonds. This property is usually associated with a cross-linking reaction of the composition constituents often induced by heat or radiation. Hawley, Gessner G., The Condensed Chemical Dictionary, Ninth Ed., page 856; Surface Coatings, vol. 2, Oil and Colour Chemists' Association, Australia, TAFE Educational Books (1974). Once cured or crosslinked, a thermosetting composition will not melt upon the application of heat, and is insoluble in solvents. By contrast, a “thermoplastic composition” comprises polymeric components that are not joined by covalent bonds and thereby can undergo liquid flow upon heating and are soluble in solvents. Saunders, K. J., Organic Polymer Chemistry, pp. 41-42, Chapman and Hall, London (1973).

As used herein, the term “polymer” is meant to encompass oligomer, and includes without limitation both homopolymers and copolymers. Also as used herein, the term “reactive” refers to a functional group that forms a covalent bond with another functional group under conditions sufficient to cure the composition. As used herein, “(meth)acrylate” and like terms are intended to include both acrylates and methacrylates.

As used herein, the term “polyisocyanate” is intended to include free or unblocked (poly)isocyanates. The polyisocyanate can be an aliphatic or an aromatic polyisocyanate, or a mixture of the foregoing two. Diisocyanates can be used, although higher polyisocyanates such as isocyanurates of diisocyanates are often used. Higher polyisocyanates also can be used in combination with diisocyanates. Isocyanate prepolymers, for example, reaction products of polyisocyanates with polyols, also can be used. Mixtures of polyisocyanate curing agents can be used.

As used herein, by “substantially pigment-free composition” is meant a composition that forms a transparent coating, such as a clearcoat in a multi-component composite coating composition. Such compositions are sufficiently free of pigment or particles such that the optical properties of the resultant coatings are not seriously compromised. As used herein, “transparent” means that the cured coating has a BYK Haze index of less than 50 as measured using a BYK/Haze Gloss instrument.

As used herein, the phrase “components are different from each other” refers to components that do not have the same chemical structure as other components in the composition.

As used herein, the term “cure” as used in connection with a composition, e.g., “composition when cured,” shall mean that any crosslinkable components of the composition are at least partially crosslinked. In certain embodiments of the present invention, the crosslink density of the crosslinkable components, i.e., the degree of crosslinking, ranges from 5% to 100% of complete crosslinking.

As used herein, the term “pot life” refers to the period of time between when the components of a two-component composition are mixed and the time at which gellation (when the viscosity of the mixture builds to the point that it cannot be coated onto a substrate) occurs. During the “pot life” time period, the viscosity of the mixed two-component composition remains low enough to allow application of the coating onto a substrate.

As used herein, the term “dust-free time” refers to the length of time between when a coating is applied to a substrate and when the coating has cured sufficiently that dust falling onto the coated substrate will blow away and not stick to the coated substrate. In automotive refinish shops, dust-free time is a key economic consideration, as it affects the turnaround time for a job, as an automobile cannot be moved until after the dust-free time has been reached.

As used herein, the term “tack-free time” refers to the length of time between when a coating is applied to a substrate and when the coating no longer feels sticky when touched. In automotive refinish shops, tack-free time is a key economic consideration as it affects the turnaround time for a job, as an automobile should not be moved until after the tack-free time has been reached.

As used herein the term “volatile” refers to compounds having a vapor pressure sufficiently high that they will evaporate quickly, as a non-limiting example after being applied to a substrate as part of a coating composition. As used herein a volatile material will typically have a vapor pressure of at least 20 mm Hg at 25° C.

The present invention is directed to a two-component film-forming composition that includes (A) a first component comprised of a polyol and a catalyst; and (B) a second component comprising an unblocked polyisocyanate; wherein at least one of components (A) and (B) comprise a volatile carboxylic acid compound and components (A) and (B) are substantially free of mercapto compounds and polyphenols.

In an embodiment of the present invention, components are mixed to form a thermosetting composition.

Any suitable polyol may be used in the present invention. Suitable polyols include, but are not limited to, polyester polyols and (meth)acrylic polyols. As non-limiting examples, the polyester polyol can include one or more condensation products of polyhydric alcohols and polycarboxylic acids. As non-limiting examples, polyhydric alcohols can be one or more alcohols selected from ethylene glycol, neopentyl glycol, trimethylol propane, and pentaerythritol. As non-limiting examples, the polycarboxylic acids are one or more selected from the group consisting of adipic acid, 1,4-cyclohexyl dicarboxylic acid, hexahydrophthalic acid, succinic acid, and functional equivalents thereof. As non-limiting examples, the polycarboxylic acid functional equivalents are one or more selected from anhydrides and C₁-C₄ alkyl esters of the acids.

As a non-limiting example, the (meth)acrylic polyol can include residues formed from the polymerization of one or more hydroxylalkyl esters of (meth)acrylic acid, particular non-limiting examples of which include the hydroxylalkyl esters of (meth)acrylic acid comprising one or more selected from the group consisting of hydroxyethyl (meth)adrylate, hydroxypropyl (meth)acrylate, polyethylene glycol esters of (meth)acrylic acid, polypropylene glycol esters of (meth)acrylic acid, and mixed polyethylene glycol and polypropylene glycol esters of (meth)acrylic acid.

In an embodiment of the present invention, the polyol has a hydroxyl-equivalent weight of at least 50, in some cases 100, in other cases 150, in some situations at least 200, and in other situations at least 250 grams per solid equivalent. Also, the polyol can have a hydroxyl equivalent weight of up to 4,000, in some cases up to 3,500, in other cases up to 3,000, in some situations up to 2,750, and in other situations up to 2,500 grams per solid equivalent. The hydroxyl equivalent weight of the polyol can vary between any of the values stated above.

The polyol is present at a level of at least 10, in some cases at least 15, in other cases at least 20, in some situations at least 25, and in other situations at least 30 percent by weight based on the resin solids of the two-component film-forming composition. Also, the polyol can be present at a level of up to 80, in some cases up to 75, in other cases up to 70, in some situations up to 65, and in other situations up to 60 percent by weight based on the resin solids of the two-component film-forming composition. The amount of polyol in the two-component film-forming composition can vary between any of the values recited above.

The first component contains a catalyst that promotes the reaction between the polyol and the unblocked polyisocyanate. Any suitable catalyst for promoting the reaction may be used in the present invention. Suitable catalysts include, but are not limited to, tin compounds, bismuth compounds, and mixtures thereof.

The catalyst is present at a level of at least 0.01, in some cases at least 0.1, in other cases at least 1, in some situations at least 2, and in other situations at least 3 percent by weight based on the resin solids of the two-component film-forming composition. Also, the catalyst can be present at a level of up to 10, in some cases up to 9, in other cases up to 7, in some situations up to 6, and in other situations up to 5 percent by weight based on the resin solids of the two-component film-forming composition. The amount of catalyst in the two-component film-forming composition can vary between any of the values recited above.

The second component (B) included an unblocked polyisocyanate. Any suitable unblocked polyisocyanate can be used in the present invention. Suitable unblocked polyisocyanates include, but are not limited to, one or more aromatic or aliphatic compounds containing two or more isocyanate groups.

In an embodiment of the present invention, the polyisocyanate includes one or more polyisocyanates selected from 1,2,4-benzene triisocyanate, polymethylene polyphenyl isocyanate, 4,4′-diphenylmethane diisocyanate, 1,3-phenylene diisocyanate, 1,4-phenylene diisocyanate, tolylene diisocyanate, 1,4-tetramethylene diisocyanate, 1,6-hexamethylene diisocyanate, 1,4-cyclohexyl diisocyanate, isophorone diisocyanate, α,α-xylylene diisocyanate, and 4,4′-methylene-bis(cyclohexyl isocyanate).

The polyisocyanate is present at a level of at least 10, in some cases at least 15, in other cases at least 20, in some situations at least 25, and in other situations at least 30 percent by weight based on the resin solids of the two-component film-forming composition. Also, the polyisocyanate can be present at a level of up to 80, in some cases up to 75, in other cases up to 70, in some situations up to 65, and in other situations up to 60 percent by weight based on the resin solids of the two-component film-forming composition. The amount of polyisocyanate in the two-component film-forming composition can vary between any of the values recited above.

In the present invention, at least one of components (A) and (B) includes a volatile carboxylic acid compound. While not being limited to a single theory, it is believed that the presence of the volatile carboxylic acid compound delays the curing or crosslinking reaction between the polyol and the polyisocyanate, extending the pot life of the two-component film-forming composition after components (A) and (B) have been mixed. Any suitable volatile carboxylic acid that can effectively extend the pot life of the mixed two-component film-forming composition may be used in the invention. Suitable volatile carboxylic acid compounds include, but are not limited to, C₁-C₄ monocarboxylic acids. In an embodiment of the present invention, the volatile carboxylic acid compound has a boiling point of less than 150° C.

In a particular embodiment of the present invention, the volatile carboxylic acid compound comprises one or more of acetic acid and propionic acid.

The volatile carboxylic acid compound is present at a level of at least 0.1, in some cases at least 1, in other cases at least 2, in some situations at least 3, and in other situations at least 4 percent by weight based on the resin solids of the two-component film-forming composition. Also, the volatile carboxylic acid compound can be present at a level of up to 20, in some cases up to 15, in other cases up to 12.5, in some situations up to 10, and in other situations up to 7.5 percent by weight based on the resin solids of the two-component film-forming composition. The amount of volatile carboxylic acid compound in the two-component film-forming composition can vary between any of the values recited above.

The two-component film-forming composition of the present invention can also include other additives and/or components that are known in the art. Such other additives and/or components include, but are not limited to, organic diluents, ultraviolet (UV) light stabilizers, ultraviolet (UV) light absorbers, pigments, rheology control agents, flow control agents, corrosion inhibitive pigments, adhesion promoters, and fillers.

Suitable UV stabilizers that can be used in the present invention include, but are not limited to, those sold under the trade name TINUVIN by Ciba Specialty Chemicals, Basel, Switzerland, and hindered-amine. light stabilizers (HALS) such as are available from Elf-Atochem, Philadelphia, Pa. The amount of UV stabilizers can be about 1×10⁻⁴ to about 10 weight percent of the total solids of the coating composition.

Suitable UV absorbers stabilizers that can be used in the present invention include, but are not limited to, benzotriazole type ultraviolet light absorber, such as BLS 5411 (Mayzo Inc., Norcross, Ga.), and trisaryl-1,3,5-triazine ultraviolet light absorbers such as those disclosed in U.S. Pat. No. 6,365,652 to Gupta et al. The amount of UV absorbers can be about 1×10⁻⁴ to about 10 weight percent of the total solids of the coating composition.

The two-component film-forming composition of the present invention can be a substantially pigment-free composition. Alternatively, the two-component film-forming composition can contain color pigments conventionally used in surface coatings and may be used as a monocoat; that is, a pigmented coating. Suitable color pigments include, for example, inorganic pigments such as titanium dioxide, iron oxides, chromium oxide, lead chromate, and carbon black; and organic pigments such as phthalocyanine blue and phthalocyanine green. Mixtures of the above mentioned pigments may also be used. Suitable metallic pigments include, in particular, aluminum flake, copper bronze flake, metal oxide-coated mica, nickel flakes, tin flakes, and mixtures thereof.

In general, the pigment is incorporated into either or both of components (A) and/or (B) of the two-component film-forming composition in amounts of up to about 80 percent by weight based on the total weight of the coating solids. The metallic pigment is employed in amounts of about 0.5 to about 25 percent by weight based on the total weight of the coating solids.

Other ingredients that may be optionally present in the two-component film-forming composition are those which are well-known in the art of formulating surface coatings and include surfactants, flow control agents, thixotropic or rheology control agents, fillers, anti-gassing agents, and other customary auxiliaries. Examples of these optional materials and suitable amounts are described in U.S. Pat. Nos. 4,220,679, 4,403,003, 4,147,769, and 5,071,904.

In an embodiment of the present invention, either or both of component (A) and component (B) can include an organic diluent. The organic diluent is optional, but when the organic diluent is present in either or both of (A) and/or (B), the organic diluent is present at a level of at least 1, in some cases at least 2.5, in other cases at least 5, in some situations at least 10, in other situations at least 20, and in some compositions at least 25 percent by weight based on the total weight of the two-component film-forming composition. Also, when the organic diluent is present, it can be present at a level of up to 80, in some cases up to 75, in other cases up to 60, in some situations up to 50, and in other situations up to 40 percent by weight based on the total weight of the two-component film-forming composition. The amount of organic diluent in the two-component film-forming composition can vary between any of the values recited above.

In this embodiment of the invention, any suitable organic diluent may be used. Suitable organic diluents that may be used in the present invention include, but are not limited to, organic diluents selected from VM & P naphtha, toluene, xylene, cyclohexane, acetone, methyl ethyl ketone, methyl isobutyl ketone, methyl amyl ketone, ethyl alcohol, propyl alcohol, diacetone alcohol, butyl acetate, hexyl acetate, mono and dialkyl ethers of ethylene, propylene glycol, diethylene glycol, ethylene glycol monoethyl ether, ethylene glycol monobutyl ether, ethylene glycol monoethyl ether acetate, diethylene glycol diethyl ether, propylene glycol monomethyl ether, dipropylene glycol ether, propylene glycol monomethyl ether acetate, and mixtures thereof.

In an embodiment of the present invention, the two-component film-forming composition is a coating composition used to coat a substrate, producing a coated substrate. The coated substrate includes a substrate and a coating layer over at least a portion of the substrate. The coating layer is thus derived from the two-component film-forming composition of the present invention.

When used as a coating composition, the present two-component film-forming composition can be a substantially pigment-free composition and used as a clear coat composition. Alternatively, the inventive two-component film-forming composition can contain one or more pigments as described above.

In the present invention, prior to using the two-component film-forming composition, components (A) and (B) are mixed together and the mixture is typically applied to a substrate. As indicated above, once applied to the substrate, the volatile carboxylic acid compound tends to inhibit, impede, retard, and/or slow down the curing or crosslinking reaction between components (A) and (B). Once the mixed two-component film-forming composition is applied to a substrate, the volatile carboxylic acid compound begins to volatilize or evaporate, thus removing itself from the coated mixture of components (A) and (B) of the two-component film-forming composition. The removal of the volatile carboxylic acid compound allows the curing or crosslinking reaction between components (A) and (B) to proceed. Thus, the pot life of the mixed two-component film-forming composition can be extended, but once the composition is applied, curing or crosslinking of the composition can take place.

Depending on the composition of the two-component film-forming composition and the volatility of the particular volatile carboxylic acid compound(s) used, the two-component film-forming composition will have a pot life of at least 15 minutes, in some situations at least 30 minutes, in some cases at least one hour, in other cases at least two hours, in some situations at least three hours, and in other cases at least four hours. Also, the two-component film-forming composition will have a pot life of up to 24 hours, in some cases up to 20 hours, in other cases up to 16 hours, in some situations up to 12 hours, and in other situations up to 8 hours. The pot life of the two-component film-forming composition can vary between any of the values stated above.

In an embodiment of the present invention and depending on the composition of the two-component film-forming composition and the volatility of the particular volatile carboxylic acid compound(s). used, the mixed two-component film-forming composition will have a dust-free time after application to a substrate of at least 1 minute, in some cases at least 2 minutes, in other cases at least 3 minutes, in some situations at least 4 minutes, and in other cases at least 5 minutes. Also, the mixed two-component film-forming composition will have a dust-free time of up to 35 minutes, in some cases up to 30 minutes, in other cases up to 25 minutes, and in some situations up to 20 minutes. The dust-free time of the mixed two-component film-forming composition can vary between any of the values stated above.

In another embodiment of the present invention and depending on the composition of the two-component film-forming composition and the volatility of the particular volatile carboxylic acid compound(s) used, the mixed two-component film-forming composition will have a tack-free time after application to a substrate of at least 1 minute, in some cases at least 2 minutes, in other cases at least 3 minutes, in some situations at least 4 minutes, and in other cases at least 5 minutes. Also, the mixed two-component film-forming composition will have a tack-free time of up to 40 minutes, in some cases up to 35 minutes, in other cases up to 32 minutes, in some situations up to 30 minutes, and in other situations up to 25 minutes. The tack-free time of the mixed two-component film-forming composition can vary between any of the values stated above.

Unlike some prior art coating compositions, the two-component film-forming composition described above is substantially free of tin and/or bismuth complexes with mercapto compounds and/or polyphenols.

An embodiment of the present invention is directed to a method of coating a substrate. The method includes the steps of (I) mixing the two-component film-forming composition described above, (II) applying the mixed composition in (I) to at least a portion of a surface of the substrate to form a coating film, and (III) curing the coating film.

Any suitable substrate can be used in the present invention. Suitable substrates include, but are not limited to, plastic substrates and metal substrates. Suitable metals include, but are not limited to, ferrous metals and aluminum. Suitable plastic substrates include, but are not limited to, natural rubber, synthetic rubber, polyurethanes, poly(meth)acrylates, polycarbonates, and other thermoplastics and thermosets known in the art.

Any suitable method can be used to apply the mixed composition to the substrate. Suitable application methods include, but are not limited to, brushing, spraying, dipping, and flowing.

In an embodiment of the present invention, the mixed composition is spray applied using one or both of compressed air spraying and electrostatic spraying.

The coating film of the present invention is cured to form a film over at least a portion of the substrate. The length of time for the coating film to cure will vary depending on the composition of the two-component film-forming composition and the volatility of the particular volatile carboxylic acid compound(s) used. In an embodiment of the present invention, the coating film is essentially completely cured at ambient temperatures after a period of time of at least 15 minutes, in some cases at least 30 minutes, in other cases at least 45 minutes, and in some situations at least one hour. Also, the length of time for the coating film to cure can be up to six hours, in some cases up to five hours, in other cases up to four hours, in some situations up to three hours, and in other situations up to two hours. The length of time for the coating film of the present invention to cure can vary between any of the values recited above.

In another embodiment of the present invention, the cured coating film is a dry film with a dry film thickness of the cured coating film of at least 2.5 microns (0.1 mil), in some cases at least 5 microns (0.2 mil), in other cases at least 10 microns (0.4 mil), in some situations at least 15 microns (0.6 mil), and in other situations at least 20 microns (0.8 mil). Also, the dry film thickness of the cured coating film can be up to 200 microns (7.9 mil), in some cases up to 150 microns (5.9 mil), in other cases up to 125 microns (4.9 mil), in some situations up to 100 microns (3.9 mil), in other situations up to 75 microns (2.9 mil), and in some circumstances up to 50 microns (2 mil). The dry film thickness of the cured coating film can vary between any of the values recited above.

In an alternative embodiment, heat can be applied to the coated substrate to accelerate the removal of the volatile carboxylic acid compound and accelerate the curing and/or crosslinking reactions. Heat is optionally applied during the curing step and, when it is, the coated substrate is heated to a temperature of at least 40° C., in some cases at least 50° C., and in other cases at least 70° C. Also, the coated substrate may be heated to a temperature of up to 200° C., in some cases up to 170° C., in other cases up to 150° C., in some situations up to 125° C., and in other cases up to 100° C. The temperature of the coated substrate can be heated to and range between any of the values stated above during the curing step.

When heat is applied during the curing step, the time for the curing and/or crosslinking reaction to be completed will be reduced. In this embodiment, the cure temperature, the composition of the two-component film-forming composition, and the volatility of the particular volatile carboxylic acid compound(s) used will affect the time for curing. In this embodiment, the time for the curing and/or crosslinking reaction to be substantially completed can be at least 5 minutes, in some cases at least 10 minutes, and in some cases at least 15 minutes. Also, when heat is applied, the time for the curing and/or crosslinking reaction to be substantially completed can be up to 4 hours, in some cases up to 3 hours, in other cases up to 2 hours, in some situations up to 1 hour, and in other situations up to 30 minutes. The time for the curing and/or crosslinking reaction to be substantially completed for the coated substrate when heat is applied can vary between any of the values indicated above.

An embodiment of the present invention is directed to a substrate coated according to the above-described method.

A particular embodiment of the present invention is directed to a method of refinishing automobiles and/or automobile parts that includes the above-described method.

A typical problem in the prior art is that methods used to extend pot life result in longer cure times and a general waviness in the cured film. The waviness typically appears in what is termed in the art as “orange peel.” An unexpected benefit of the present invention is that not only is pot life extended and cure times, dust-free times and tack-free times kept at economic levels, but the degree of orange peel in the final coating is also generally reduced.

Orange peel, which is a visual, not tactile, phenomenon, is typically evaluated by taking laser-optical measurements on the finished coating surface. Suitable instruments for measuring orange peel include, but are not limited to, the Wave-Scan instruments available from BYK-Gardner, Columbia, Md.

The present invention is more particularly described in the following examples, which are intended to be illustrative only, since numerous modifications and variations therein will be apparent to those skilled in the art. Unless otherwise specified, all parts and percentages are by weight.

### EXAMPLES 1-4

The following coating compositions were prepared by mixing the components shown in the table below.

| | Example 1 | Example 2 | Example 3 | Example 4 |
|---|---|---|---|---|
| Raw Materials | (g) | (g) | (g) | (g) |
| Clear Component | | | | |
| Methyl Amyl | 11.33 | 11.33 | 11.33 | 11.33 |
| Ketone | | | | |
| Methyl Isobutyl | 13.27 | 13.27 | 13.27 | 13.27 |
| Ketone | | | | |
| Byk 300¹ | 0.47 | 0.47 | 0.47 | 0.47 |
| Chisorb 328² | 1.23 | 1.23 | 1.23 | 1.23 |
| Sanol LS 292³ | 1.68 | 1.68 | 1.68 | 1.68 |
| Acrylic Polyol 1⁴ | 71.55 | 71.55 | 71.55 | 71.55 |
| Acrylic Polyol 2⁵ | 32.87 | 32.87 | 32.87 | 32.87 |
| Dibutyl Tin | 0.35 | 0.35 | — | — |
| Dilaurate | | | | |
| Propionic Acid | — | 0.51 | 0.35 | 0.35 |
| Tin-Mercaptide⁶ | — | — | — | 0.51 |
| Crosslinker | | | | |
| Component | | | | |
| Isocyanate | 41.76 | 41.76 | 41.76 | 41.76 |
| Solution⁷ | | | | |
| Reducer | | | | |
| Reducing Solvent⁸ | 29.34 | 29.34 | 29.34 | 29.34 |
| TOTAL | 203.85 | 204.36 | 203.85 | 204.36 |

¹Rheological additive available from BYK Chemie USA, Wallingford, CT.
²UV absorber available from Chitec Chemical Company, Ltd., Taipei, Taiwan.
³Hindered amine light stabilizer available from Sankyo Company Ltd., Tokyo, Japan.
⁴Low Tg acrylic polyol copolymer of methyl methacrylate, hydroxypropyl acrylate, styrene and an adduct of glycidal methacrylate, and isostearic acid.
⁵High Tg acrylic polyol copolymer of methyl methacrylate, butyl methacrylate, styrene, hydroxypropyl acrylate, acrylic acid, and an adduct of acrylic acid and the glycidyl ester of versatic acid.
⁶Metatin 715 tin mercaptide available from Acima AG, Buchs, Switzerland.
⁷DCX-61 available from PPG Industries Inc., Pittsburgh, PA.
⁸DT870 available from PPG Industries Inc., Pittsburgh, PA.

Example 4 is analogous to the system of EP 0 454 219 A1, which uses a complexed catalyst of tin and mercapto compounds together with a volatile acid.

The coating formulations were applied to APR 41428 panels, available from ACT Laboratories, Hillsdale, having a black basecoat (D9700, PPG Industries, Inc.), using a DeVillbis GTI Millenium spraygun (DeVillbis Air Power Co., Jackson, Tenn.) equipped with a 1.2 mm tip and 30 psi at the gun. Two coats were applied to the panels for a total dry film thickness of 2.3 to 2.7 mils.

The sprayed panels were evaluated for dust-free and tack-free times at ambient conditions. Dust-free time was determined as the time required for the coated film to sufficiently dry so that a cotton ball placed on its surface would not adhere when the panel was inverted. Tack-free time was determined as the time required for the film to dry sufficiently so that a finger placed of the surface did not detect any tackiness in the film.

The results are shown in the following tables below.

Pot Life
(Viscosity of coating formulation in cps)

| | Initial | 15 min. | 30 min. | 45 min. | 60 min. | 75 min. | 90 min. | 105 min. | 120 min. |
|---|---|---|---|---|---|---|---|---|---|
| Example 1 | 29 | 32 | 42 | 44 | 50 | 65 | 76 | 97 | 130 |
| (Comparative) | | | | | | | | | |
| Example 2 | 28 | 30 | 34 | 37 | 40 | 50 | 57 | 65 | 74 |
| (Inventive) | | | | | | | | | |
| Example 3 | 28 | 30 | 37 | 42 | 55 | 75 | 98 | 150 | 175 |
| (Comparative) | | | | | | | | | |
| Example 4 | 31 | 31 | 34 | 35 | 41 | 47 | 52 | 60 | 72.5 |
| (Comparative) | | | | | | | | | |

Cure Speed

| | Dust-free Time | Tack-free Time |
|---|---|---|
| | (min.) | (min.) |
| Example 1 | 23 | 32 |
| (Comparative) | | |
| Example 2 | 25 | 32 |
| (Inventive) | | |
| Example 3 | 26 | 31 |
| (Comparative) | | |
| Example 4 | 29 | 36 |
| (Comparative) | | |

The results show that the compositions of the present invention (Example 2) provide an improved and surprising combination of long pot life (viscosity under 100 cps after 120 minutes) and fast cure speed (10-20% faster than Example 4).

The present invention has been described with reference to specific details of particular embodiments thereof. It is not intended that such details be regarded as limitations upon the scope of the invention except insofar as and to the extent that they are included in the accompanying claims.

1. A two-component film-forming composition comprising:
(A) a first component comprised of:
(i) a polyol; and
(ii) a catalyst;
(B) a second component comprising an unblocked polyisocyanate; wherein at least one of components (A) and (B) comprise a volatile carboxylic acid compound, and components (A) and (B) are substantially free of mercapto compounds and polyphenols.

2. The composition of claim 1, wherein the polyol is one or both of a polyester polyol and an acrylic polyol.

3. The composition of claim 2, wherein the polyester polyol comprises one or more condensation products of polyhydric alcohols and polycarboxylic acids.

4. The composition of claim 3, wherein the polyhydric alcohols are one or more alcohols selected from the group consisting of ethylene glycol, neopentyl glycol, trimethylol propane, and pentaerythritol.

5. The composition of claim 3, wherein the polycarboxylic acids are one or more selected from the group consisting of adipic acid, 1,4-cyclohexyl dicarboxylic acid, hexahydrophthalic acid, succinic acid, and functional equivalents thereof.

6. The composition of claim 5, wherein the polycarboxylic acid functional equivalents are one or more selected from the group consisting of anhydrides and C₁-C₄ alkyl esters of the acids.

7. The composition of claim 2, wherein the acrylic polyol comprises residues formed from the polymerization of one or more hydroxylalkyl esters of (meth)acrylic acid.

8. The composition of claim 7, wherein the hydroxylalkyl esters of (meth)acrylic acid comprise one or more selected from the group consisting of hydroxyethyl (meth)acrylate, hydroxypropyl (meth)acrylate, polyethylene glycol esters of (meth)acrylic acid, polypropylene glycol esters of (meth)acrylic acid, and mixed polyethylene glycol and polypropylene glycol esters of (meth)acrylic acid.

9. The composition of claim 2, wherein the polyol has a hydroxyl equivalent weight of from 50 to 4000 grams per solid equivalent.

10. The composition of claim 1, wherein the catalyst is selected from tin compounds, bismuth compounds, and mixtures thereof.

11. The composition of claim 1, wherein the unblocked polyisocyanate comprises one or more aromatic or aliphatic compounds containing two or more isocyanate groups.

12. The composition of claim 11, wherein the polyisocyanate comprises one or more selected from the group consisting of 1,2,4-benzene triisocyanate, polymethylene polyphenyl isocyanate, 4,4′-diphenylmethane diisocyanate, 1,3-phenylene diisocyanate, 1,4-phenylene diisocyanate, tolylene diisocyanate, 1,4-tetramethylene diisocyanate, 1,6-hexamethylene diisocyanate, 1,4-cyclohexyl diisocyanate, isophorone diisocyanate, α,α-xylylene diisocyanate, and 4,4′-methylene-bis(cyclohexyl isocyanate).

13. The composition of claim 1, wherein the volatile carboxylic acid compound is a C₁-C₄ monocarboxylic acid.

14. The composition of claim 1, wherein the volatile carboxylic acid compound has a boiling point of less than 150° C.

15. The composition of claim 13, wherein the volatile carboxylic acid compound comprises one or more of acetic acid and propionic acid.

16. The composition of claim 1, wherein (A) and/or (B) further comprise one or more components selected from the group consisting of organic diluents, ultraviolet light stabilizers, ultraviolet light absorbers, pigments, rheology control agents, flow control agents, corrosion inhibitive pigments, adhesion promoters, and fillers.

17. The composition of claim 1, wherein the film-forming composition is a clear coat composition.

18. The composition of claim 1, wherein the film-forming composition contains a pigment.

19. The coating composition of claim 1, comprising 20 to 80 percent of component (A) and 20 to 80 percent of component (B), based on total resin solids weight of (A) plus (B).

20. The composition of claim 16, wherein one or both of component (A) and component (B) include the organic diluent at from 25 to 40 percent by weight of the total composition.

21. The composition of claim 16, wherein the organic diluent is selected from the group consisting of VM & P naphtha, toluene, xylene, cyclohexane, acetone, methyl ethyl ketone, methyl isobutyl ketone, methyl amyl ketone, ethyl alcohol, propyl alcohol, diacetone alcohol, butyl acetate, hexyl acetate, mono and dialkyl ethers of ethylene, propylene glycol, diethylene glycol, ethylene glycol monoethyl ether, ethylene glycol monobutyl ether, ethylene glycol monoethyl ether acetate, diethylene glycol diethyl ether, propylene glycol monomethyl ether, dipropylene glycol ether, propylene glycol monomethyl ether acetate, and mixtures thereof.

22. The composition of claim 1, wherein components (A) and (B) are mixed together.

23. The composition of claim 22, having a dust-free time of not more than 25 minutes.

24. The composition of claim 22, having a tack-free time of not more than 32 minutes.

25. A coated substrate comprising a substrate and a coating layer over at least a portion of the substrate, wherein the coating layer is derived from the two-component film-forming composition of claim 1.

26. A method of coating a substrate comprising:
(I) mixing a two-component film-forming composition comprising:
(A) a first component comprised of:
(i) a polyol; and
(ii) a catalyst; and
(B) a second component comprising an unblocked polyisocyanate; wherein at least one of components (A) and (B) comprise a volatile carboxylic acid compound and components (A) and (B) are substantially free of mercapto compounds and polyphenols;
(II) applying the mixed composition in (I) to at least a portion of a surface of the substrate to form a coating film; and
(III) curing the coating film.

27. The method of claim 26, wherein the mixed composition is applied to the substrate using one or more methods selected from the group consisting of brushing, spraying, dipping, and flowing.

28. The method of claim 27, wherein spraying is accomplished by a method selected from the group consisting of compressed air spraying and electrostatic spraying.

29. The method of claim 26, wherein the dry film thickness of the cured coating film is from 2.5 to 200 microns.

30. The method of claim 26, wherein the coating film is essentially completely cured at ambient temperatures for a period of time of from 15 minutes to six hours.

31. The method of claim 26, wherein the coating film is essentially completely cured at from 40° C. to 200° C. for a period of time of from 5 minutes to four hours.

32. The method claim 26, wherein the polyol is one or both of a polyester polyol and an acrylic polyol.

33. The method of claim 26, wherein the polyol hash a hydroxyl equivalent weight of from 50 to 4000 grams per solid equivalent.

34. The method of claim 26, wherein the catalyst is selected from tin compounds, bismuth compounds, and mixtures thereof.

35. The method of claim 26, wherein the unblocked polyisocyanate comprises one or more aromatic or aliphatic compounds containing two or more isocyanate groups.

36. The method of claim 26, wherein the volatile carboxylic acid compound is a C₁-C₄ monocarboxylic acid.

37. The method of claim 26, wherein the volatile carboxylic acid compound has a boiling point of less than 150° C.

38. The method of claim 26, wherein the volatile carboxylic acid compound comprises one or more of acetic acid and propionic acid.

39. The method of claim 26, wherein (A) and/or (B) further comprise one or more components selected from the group consisting of organic diluents, ultraviolet light stabilizers, ultraviolet light absorbers, pigments, rheology control agents, flow control agents, corrosion inhibitive pigments, adhesion promoters, and fillers.

40. The method of claim 26, wherein the film-forming composition is a clear coat composition.

41. The method of claim 26, wherein the film-forming composition contains a pigment.

42. The method of claim 26, wherein the composition in (I) comprises 20 to 80 percent of component (A) and 20 to 80 percent of component (B), based on total resin solids weight of (A) plus (B).

43. The method of claim 39, wherein one or both of component (A) and component (B) include the organic diluent at from 25 to 40 percent by weight of the total composition.

44. The method of claim 39, wherein the organic diluent is selected from the group consisting of VM & P naphtha, toluene, xylene, cyclohexane, acetone, methyl ethyl ketone, methyl isobutyl ketone, methyl amyl ketone, ethyl alcohol, propyl alcohol, diacetone alcohol, butyl acetate, hexyl acetate, mono and dialkyl ethers of ethylene, propylene glycol, diethylene glycol, ethylene glycol monoethyl ether, ethylene glycol monobutyl ether, ethylene glycol monoethyl ether acetate, diethylene glycol diethyl ether, propylene glycol monomethyl ether, dipropylene glycol ether, propylene glycol monomethyl ether acetate, and mixtures thereof.

45. The method of claim 26, wherein the film is such that it has a dust-free time of not more than 25 minutes.

46. The method of claim 26, wherein the film is cured such that it has a tack-free time of not more than 32 minutes.

47. A substrate coated according to the method of claim 26.

48. A method of refinishing automobile parts comprising the method of claim 26.

49. The coated substrate of claim 47, wherein the substrate is a metal substrate.
